(19) United States
(12) Patent Application Publication
(10) Pub. No.: US 2006/0200335 A1
(43) Pub. Date: Sep. 7, 2006

(54) Device and method for outputting translated text

(75) Inventors: Katsuhiko Itonori, Ashigarakami-gun (JP); Hiroaki Ikegami, Ashigarakami-gun (JP); Hideaki Ashikaga, Ashigarakami-gun (JP); Shunichi Kimura, Ashigarakami-gun (JP); Hiroki Yoshimura, Ashigarakami-gun (JP); Masanori Onda, Ashigarakami-gun (JP); Masahiro Kato, Ashigarakami-gun (JP); Masanori Satake, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/221,760

(22) Filed: Sep. 9, 2005

(30) Foreign Application Priority Data
Mar. 4, 2005 (JP) 2005-060735

(51) Int. Cl. G06F 17/28

(52) U.S. Cl. 704/2

(57) ABSTRACT

A device for outputting translated document has a document input part that inputs document data to be translated; a translation part that translates the document data inputted by the document input part; an output destination specifying part that specifies an output destination of the translated document for each target language; and an output destination switching part that switches the output destination of the translated document data based on the output destination specified by the output destination specifying part.

### BACKGROUND OF THE INVENTION

1. Field of the Invention

The present invention relates to a device and a method for outputting a translated document, and can be used for preparing and outputting a translated text of a document, or for receiving a translated text from an external translation device and outputting the translated text.

2. Description of the Related Art

Various types of devices for outputting translated document have been proposed. One such device converts image data of a document read by an image reading device into document data, converts the document data into translated document data of a specified language, and prints the translated document data.

Such a device for outputting translated document generates plural sets of translated document in different languages and feeds them to the same output tray. As a result, a user may be required to sort through plural sets of translated document in different languages which have collected in the output tray of the device so as to find his/her translated document. For a user to sort through plural sets of translated document in different languages, which may or may not remain in the output tray in order, so as to find his/her set of translated document is both time-consuming and inefficient. To address this problem, a technique has been proposed whereby plural sets of translated document are differentiated by being marked before output. However, this technique suffers from a drawback in that only a division between plural sets of translated document is differentiated, and it is therefore necessary for a user to identify each page of his/her translated document set individually from among pages of other sets of translated document, possibly in differing languages, in the output tray.

The present invention has been made in view of the problems of the related art described above, and provides a device for outputting translated document that enables a user to easily locate and collect from among plural sets of translated document a set of translated document that has been generated in accordance with the user's instruction.

### SUMMARY OF THE INVENTION

The present invention provides a device for outputting translated document, the device including: a document input part that inputs document data to be translated; a translation part that translates the document data inputted by the document input part; an output destination specifying part that specifies an output destination of the translated document for each target language; and an output destination switching part that switches the output destination of the translated document data based on the output destination specified by the output destination specifying part.

### BRIEF DESCRIPTION OF THE DRAWINGS

Embodiments of the present invention will now be described in detail with reference to the accompanying figures, wherein:

FIG. 1 is a block diagram showing the basic configuration of a device for outputting translated document according to one embodiment of the present invention;

FIG. 2 is a block diagram showing one example of a specific configuration of the device for outputting translated document of the embodiment;

FIG. 3 is a diagram illustrating the contents of a management table of the embodiment;

FIG. 4 is a diagram illustrating one example of operation of a user interface of the embodiment;

FIG. 5 is a diagram illustrating one example of operation of a user interface according to the embodiment;

FIG. 6 is a diagram illustrating one example of operation of a user interface provided in the embodiment;

FIG. 7 is a diagram illustrating one example of operation of a user interface provided in the embodiment;

FIG. 8 is a diagram illustrating another embodiment of the present invention; and

FIG. 9 is a diagram illustrating a still further embodiment of the present invention.

### DETAILED DESCRIPTION OF THE INVENTION

Referring to the drawings, one embodiment of the present invention will now be explained.

<Basic Configuration>

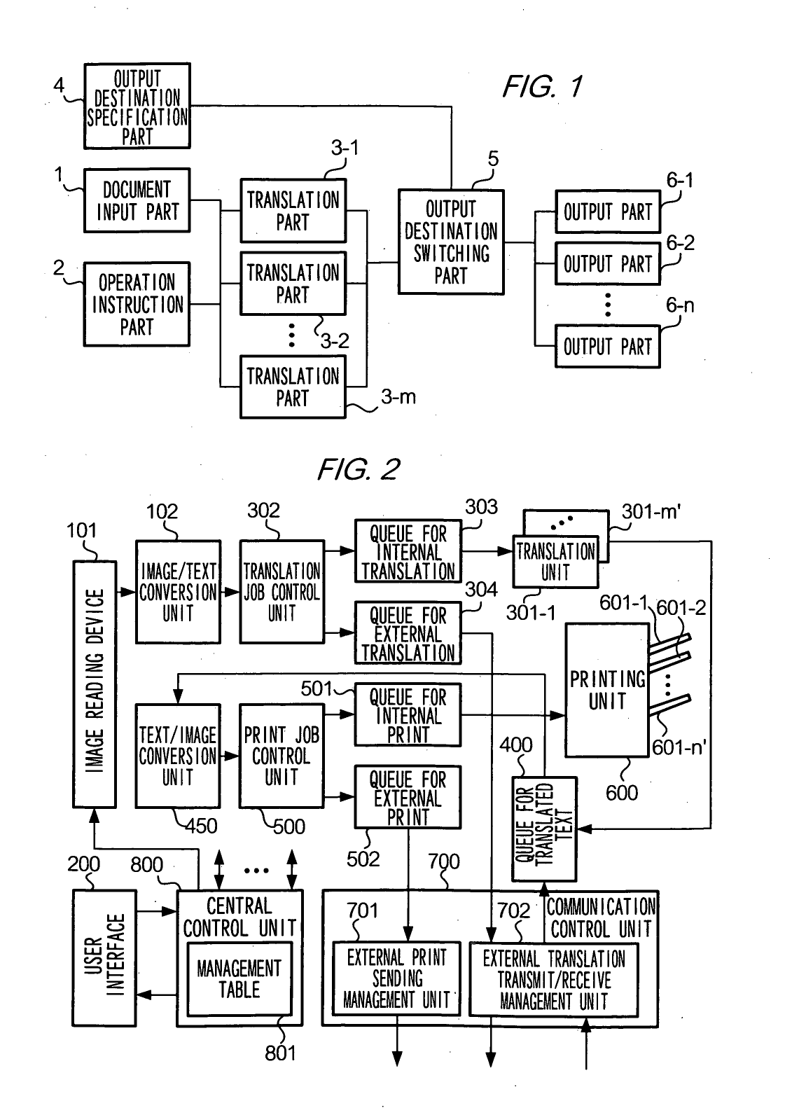

FIG. 1 is a block diagram showing the basic configuration of a device for outputting translated document, according to one embodiment of the invention. In FIG. 1, a document input part 1 enables a user to input a document to be translated (hereinafter, “translation object”). The document input part may be a part that reads image data of a translation object for conversion of the image data of the object to text data; or it may be a part that receives from, for example, a personal computer, text data of a translation object. An operation instruction part 2 is a part that receives from a user a variety of instructions relating to a translation job. Among the main instructions which are received by the part include those relating to a language of a translation object (hereinafter, “source language”) and to the language to which the document is to be translated (hereinafter, “target language”).

Translation part 3-i (i=1˜m) is a part for translating text in a source language, which is input through the document input part 1, to text in a target language. In the present embodiment, each translation part 3-i (i=1˜m) is dedicated to translating a specific language. For example, translation part 3-1 is dedicated to translating Japanese to English, and translation part 3-2 to translating Japanese to French. Which translation part 3-i (i=1˜m) is used for translation of a specific language is determined on the basis of the type of a target language. By incorporating a translation function in a device which is provided with both scanning and printing functions, it is possible according to the present invention to provide an integrated device which is capable of processing a translation object in a source language and of outputting a translated document in a desired target language. According to another embodiment, the device for outputting translated document may also be configured such that a translation function is carried out either wholly or partly by an external translation server which provides the text to the output device. In this case, either all or a part of the translation part 3-i (i=1˜m) is substituted by an external translation server for use with the output device. In such a configuration, a communication part for exchanging document data and translated document data with the external translation server is included in the configuration shown in FIG. 1.

An output destination specifying part 4 is a part that enables a user to specify a destination of a translated document. In the present embodiment, a destination to which a translated document is to be output is specified according to a target language. When receiving a translated document from any of translation part 3-i (i=1˜m), an output destination switching part 5 checks the language of the translated document, and on the basis of the language of the text determines an output destination for the translated document, and sends the translated document data to the appropriate output destination. An output part 6-j (j=1˜n) is a part to which translated document data is output; the output part outputs the translated document data provided via the output destination switching part 5 in a form which is usable by a user, for example, as a print-out. Accordingly, the output part 6-j (j=1˜n) can be provided either in part or in its entirety as a printer or a facsimile.

<Specific Configuration>

FIG. 2 is a block diagram showing one specific configuration of the device for outputting translated document of the present embodiment. In FIG. 2, an image reading device 101 and an image/text conversion unit 102 form a part of document input part shown in FIG. 1. The image reading device 101 is a device for reading image data of a print-out of a (source language) document, and for outputting the image data. When a voluminous document is required to be processed, the image reading device 101 having an ADF (Automatic Document Feeder) function may also be used. The image/text conversion unit 102 is a unit for performing character recognition processing of image data output from an image reading device, and for outputting text data.

A user interface 200 has a liquid crystal display and an operation panel for enabling a user to read information data and to input instructions. A central control unit 800 has a processor and a memory, and is used for controlling the overall functioning of the device for outputting translated document.

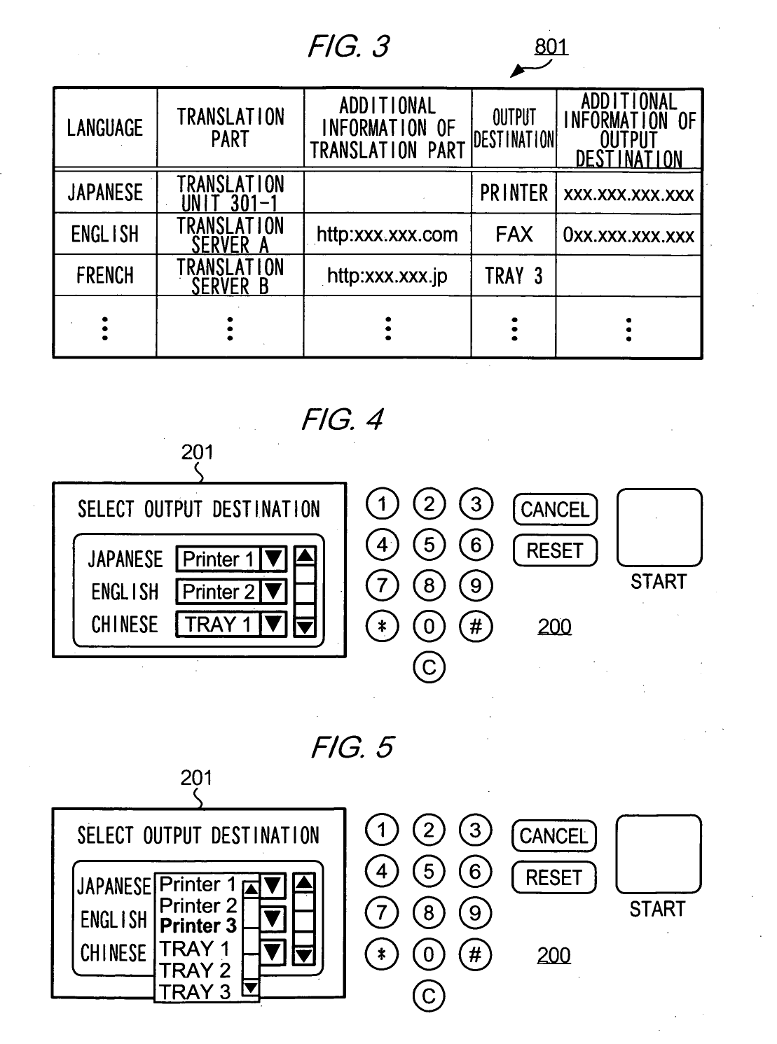

The user interface 200 and the central control unit 800 cooperate to act as the operation instruction part 2 and the output destination specifying part 4 of FIG. 1; and the interface also functions as a part of the output destination switching part 5 of FIG. 1. In other words, the central control unit 800, by way of the user interface 200, receives information from a user for each translation language; which information relates to a translation part used for translation, additional information of the translation part, to an output destination of a translated document, additional information of the output destination, and prepares a management table 801, as illustrated in FIG. 3, and stores the table in the memory. When image data of a translation object is read by the image reading device 101, the device for outputting translated document determines, on the basis of the source language of the translation object, and the management table 801, a translation part for translating the translation object; and decides, also on the basis of a target language of the translation object, and management table 801, a destination of the translated document. The device for outputting the translated document further performs a control function for providing document data (text data) to a translation part and a control function for providing translated document data (image data) to an output destination.

It is to be noted that information specifying the source language and information specifying the target language are acquired by the central control unit 800 via the user interface 200. When image data of a translation object is read by the image reading device 101, the central control unit 800 issues an ID for the document, and also provides to each unit required for performing particular operation, the ID, information specifying the original language, and information specifying the target language, which information is acquired by way of the user interface 200.

Translation unit 301-i (i=1˜m′) is a part of translation part 3-i (i=1˜m). The translation part 3-i (i=1˜m) may also be an external translation server which is made available via a network (not shown). A translation job control unit 302 is a unit for allocating a translation job to either translation unit 301-i (i=1˜m′) or to the external translation server.

More specifically, when image data of a translation object of a document is read by the image reading device 101, the translation job control unit 302 sets the text data of the document output from the image/text conversion unit 102 as a main body, and adds to the main body a header including: the ID of the document provided from the central control unit 800; information specifying the original language; and information specifying the target language, to generate translation job data. Then, the translation job control unit 302 refers to the management table 801 in the central control unit 800 to determine a translation part corresponding to the target language specified by the information in the header of the translation job data. As a result, when a translation part determined as a result of identification is any one of translation unit 301-i (i=1˜m′) included in the device for outputting translated document, the translation job control unit 302 adds information specifying the translation part to a header and stores the translation job data in a queue for internal translation 303. When a translation part determined as a result of identification is an external translation server, the translation job control unit 302 adds information specifying the translation part to a header and stores the translation job data in a queue for external translation 304.

The translation job data stored in the queue for external translation 304 are extracted in a sequential order from the old data and passed to any one of translation unit 301-i (i=1˜m′). Determination as to which data is to be passed to which translation unit is made on the basis of the information, identifying a translation part, which information is included in the header of translation job data. Translation unit 301-i which receives the translation job data translates the text data of the main body in the translation job data to a target language specified by the information in the header. The translation unit replaces the text data of a translated document with the main body in the translation job data, and stores the translation job data in a queue for translated text 400.

A communication control unit 700 has a separate print management unit 701 and an external translation transmit/receive management unit 702. The external print management unit 701 is a unit for requesting a printer connected via LAN or a facsimile connected via a network to print a translated document. The external translation transmit/receive management unit 702 is a unit for requesting a translation server connected via a network to perform a translation. More specifically, when receiving translation job data stored in the queue for external translation 304 in a sequential order, the external translation transmit/receive management unit 702 refers to the management table 801 of the central control unit 800, so as to search for additional information of a translation part specified by information included in a header of the translation job data (in the present embodiment, the translation part is an external translation server), and accesses a translation server identified by a URL (additional information) via a network. The external translation transmit/receive management unit 702 sends the translation job data to the translation server and requests translation of text data included in the translation job data. After receiving the request and upon completion of a translation, the translation server replaces the text data of a translated document with the main body in the translation job data and returns the substituted translation job data. When receiving the translation job data, which includes the text data of the translated document from the translation server, the external translation transmit/receive management unit 702 stores the data in a queue for translated text 400.

A text/image conversion unit 450 extracts in a sequential order from the old data translation job data stored in the queue for translated text 400, incorporates the sequentially extracted data into to the new data, and converts the text data included in the main body of the translation job data to image data. Then, the text/image conversion unit substitutes the main body of the translation job data with image data and passes the substituted translation job data to a print job control unit 500.

The print job control unit 500 is a unit for controlling allocation of a print job of a translated document to a printing unit 600, to an external printer, or to a facsimile. When receiving translation job data from the text/image conversion unit 450, the print job control unit 500 refers to the management table 801 in the central control unit 800 and determines an output destination on the basis of the target language specified by the information included in the header of the translation job data. When the output destination is determined as being any one of the trays included in the printing unit 600 of the device for outputting translated document, the print job control unit 500 adds information identifying the tray to the header of the translation job data and generates print job data; then, the unit stores the data in a queue for internal print 501. On the other hand, when the output destination is determined to be a printer connected to LAN or a facsimile, the print job control unit 500 adds information identifying the output destination to the header of the translation job data, to generate print job data and stores the data in a queue for external print 502.

The printing unit 600 extracts print job data in a sequential order from the old data stored in the queue for internal print 501, prints on paper the image data included in a main body of the job data, and feeds the printed paper to a tray specified by the information included in the header of the print job data among tray 601-j (j=1˜n′). The printing unit 600 and tray 601-j (j=1˜n′) is a part of output part 6-j (j=1˜n). The other part of output part 6-j (j=1˜n) is an external printer of the device for outputting translated document, or is a facsimile. The queue for external print 502 and the external print management unit 701 of the communication control unit 700 is a unit for requesting the external output part to perform a print job. The external print management unit 701 receives print job data stored in the queue for external print 502 in a sequential order from the old data and refers to the management table 801 included in the central control unit 800, to search for additional information of an output destination (in the case of a printer, the additional information refers to a communication address in a LAN; while in the case of a facsimile, the additional information refers to a facsimile number) specified by the information included in a header of the print job data. It is to be noted that in the present embodiment, the output destination is either a printer or a facsimile. The external print management unit 701, using obtained additional information, accesses the output destination and sends to the image data included in a main body of the print job data.

An example of a specific operation performed in the device for outputting translated document will now be explained. When using the device for outputting translated document, a user operates the user interface 200 and specifies both the output destination of a translated document and a translation part to be used for a translation. FIG. 4 shows an initial state for receiving instructions for output destination of a translated document. As shown in the figure, in an initial state, a default value of the output destination of the translated document is displayed on a liquid crystal panel 201 for each target language; such as, “Printer1” for Japanese, “Printer2” for English, and “Tray 1” for Chinese. When a user performs in a display mode an operation for selecting a specific language, a list of candidates that can be selected as an output destination for the translated document for the language is displayed, as shown in FIG. 5. When a user performs an operation for selecting one output destination from among those shown in the list, the selected candidate is updated as an output destination for the translated document for the language. It is assumed that a device specified as an output destination for a translated document in one target language will not be specified as an output destination of a translated document for a different target language. To achieve such a configuration, the central control unit 800 can also be provided with a function of either displaying an alarm on the liquid crystal display 201, or rejecting the specification of under a condition that the device is specified as an output destination for a translated document for one language, and the same device is specified as an output destination for a translated document for a different language.

The process of accepting a specification of a translation part to be used for a translation is the same as that for accepting a specification of an output destination. A user manipulates the user interface 200 to input in advance additional information relating to both a translation part and an output destination. When the necessary information is input, management table 801 shown in FIG. 3 is stored in the central control unit 800. The central control unit 800 sends language information specifying the target language to be output to a device specified as an output destination of a translated document in the management table 801.

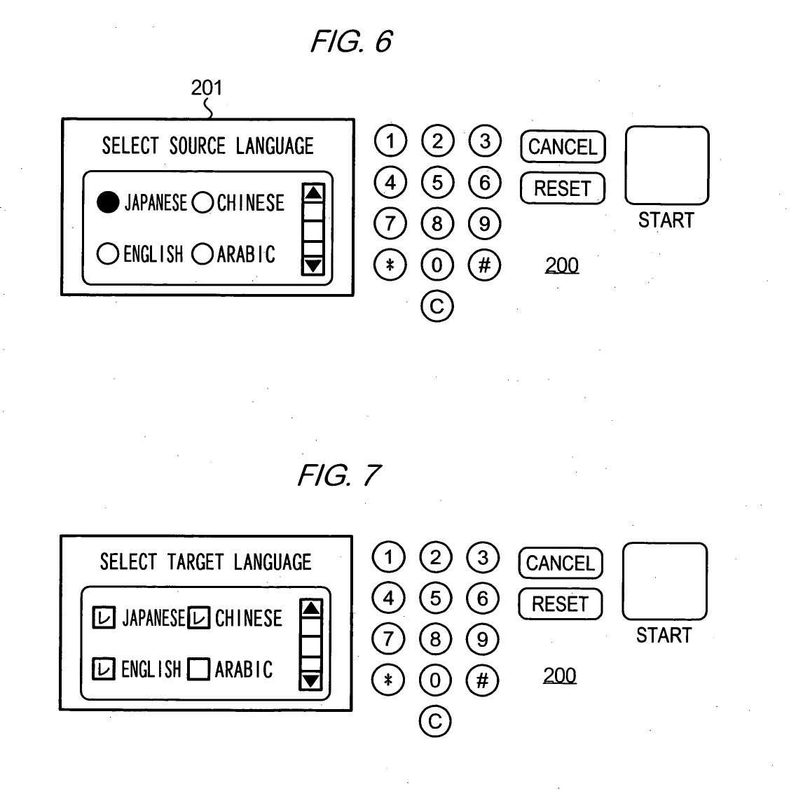

To input a document, a user specifies both a source and a target language. FIG. 6 shows a state where the user interface 200 accepts a source language. In FIG. 6, “Japanese” is specified as the default source language. To change the source language, a user performs a set operation via the user interface 200. FIG. 7 shows the mode in the user interface 200 for accepting specification of a target language. In the present embodiment, it is possible to specify plural target languages. In the example shown in the figure, French, Chinese, and English are each specified as a target language.

When the source and target language specification processes have been completed, the user places a document on the receiving tray of the image reading device 101 and presses a start button. In response to the instruction, an ADF of the image reading device 101 is activated, and the document is read in image form one page at time. The image data is then output. When image reading is performed, the central control unit 800 sends an ID along with information specifying the source language and information specifying the target language to the translation job control unit 302. When “Japanese” is specified as the source language and “French”, “Chinese”, and “English” is specified as the target language, as shown in FIG. 7, three IDs are issued and three sets of translation job data are generated by the translation job control unit 302. Thus, the header in each set of data indicates “Japanese” as the source language, and indicates “French”, “Chinese”, and “English” as the target languages, respectively.

The translation job data is sent on the basis of the target languages defined in the data header to translation parts defined by the management table 801. The translation job data used for translation by a translation part is stored in a queue for translated text 400. When the main body, of the translated document, as text data, is substituted with image data by the text/image conversion unit 450, the translation job data is then generated as print job data. At the time of generation, the target language defined in the header of translation job data and the management table 801 are referred to so that information indicating an output destination corresponding to the target language is added to the header of the print job data. Accordingly, the image data of the main body of the print job data is output from the output destination determined on the basis of the target language.

As described above, according to one embodiment of the present invention, a translated document is fed from an output destination determined on the basis of a target language. Therefore, to collect a translated document, a user simply goes to an output destination designated for a desired target language of a translation job. In this way, a user can efficiently identify and obtain a translated document from among plural sets of translated document in different languages.

While in the foregoing, one embodiment of the present invention has been explained, the present invention is not limited to the embodiment and a variety of other embodiments and configurations will be anticipated by those skilled in the art, and all such embodiments are intended to be included within the scope of the appended claims. By way of example, further embodiments are described below.

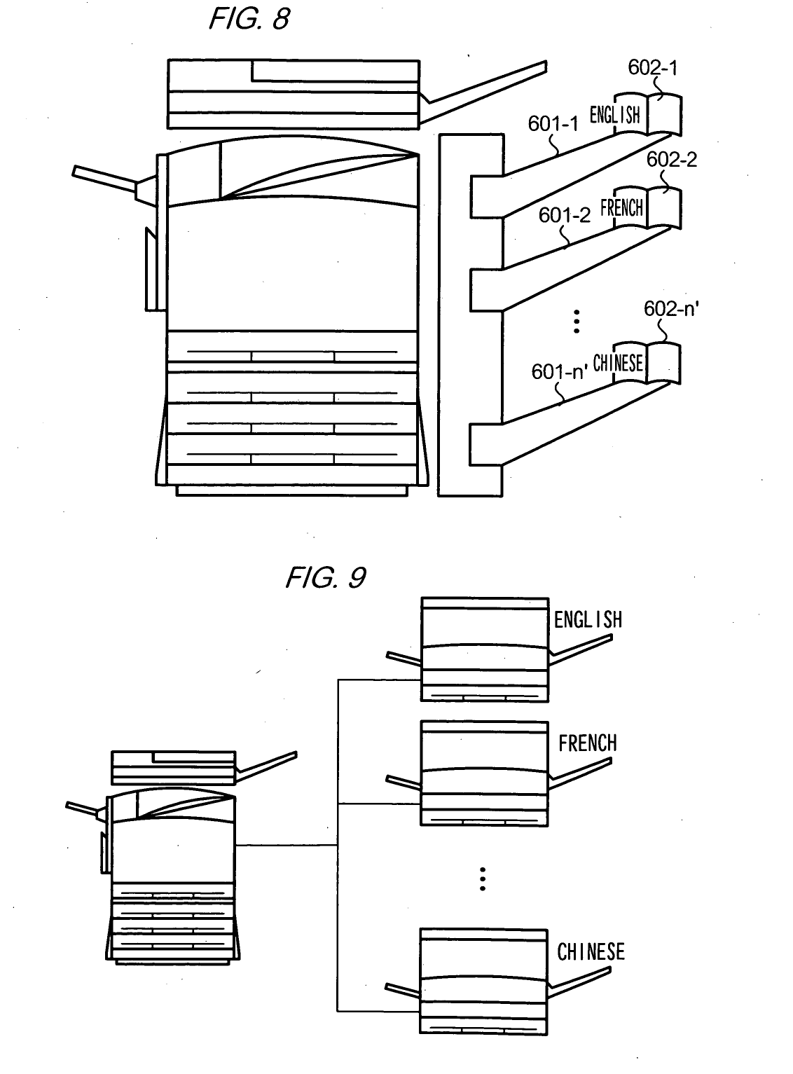

(1) As shown in FIG. 8, LED (Light Emitting Diode) 602-j (j=1˜n′) dedicated for displaying a language is provided at the tray 601-j (j=1˜n′) of the printing unit 600. The printing unit 600 receives from the central control unit 800 language information specifying the target language fed from each tray; then, on the basis of the language information, displays by way of the LED the language type of a translated document fed from each tray 602-j (j=1˜n′). In the present embodiment, it is readily apparent to a user which translated document in which target language will be fed to which tray. Therefore, a user is able to easily determine a tray to which a particular translated document will be provided.

(2) In the embodiment described above, an external printer is used as the output destination for the translated document. As shown in FIG. 9, a dedicated printer is used for a particular target language. Thus, one printer is dedicated for printing English translations while another is dedicated for outputting French translations. To select a suitable printer, a user should first determine which tray is used for output of which language type of translated document. A display unit, therefore, is provided at a location where it can be easily viewed by a user. Each printer displays a target language of a translated document fed from a printer on the basis of language information sent from the central control unit 800 of the device for outputting translated document. In this embodiment, a user is able to identify the printer that is feeding the translated document of the desired target language by viewing the display unit.

The present invention provides a device for outputting translated document, the device including: a document input part that inputs document data to be translated; a translation part that translates the document data inputted by the document input part; an output destination specifying part that specifies an output destination of the translated document for each target language; and an output destination switching part that switches the output destination of the translated document data based on the output destination specified by the output destination specifying part. According to an embodiment of the invention, translated documents are output from output destinations specified for each language of translated documents; thus, even plural sets of translated document in different languages is output, a user is able to easily locate and collect a translated document set that has been generated in accordance with the user's instruction among the translated documents collected in the output tray of the device.

In another embodiment, the device for outputting translated document may further include the output part that outputs the translated document.

In a still further embodiment, the device for outputting translated document may further include: a communication part that communicates with an external device; wherein, the output destination switching part performs control for sending the translated document data of a particular language to the external device by the communication part, when an external output part is specified by the output destination specifying part as an output destination for a translated document of the particular language.

In a still further embodiment, the device for outputting translated document may further include: a designation part that designates the translation part which is requested to perform a translation for each target language; and a controller that performs switching control of a path of the document data, so that document data to be translated into a particular language is provided to the designated translation part for translation to the particular language.

In a still further embodiment, the device for outputting translated document, wherein the output destination specifying part may further include a part that sends information indicating a target language to an output device specified as an output destination of the target language.

In a still further embodiment, the device for outputting translated document, wherein: the output destination specifying part may further include a part that sends information indicating a target language to an output device specified as an output destination of the target language; and the output device includes a display that displays a type of language when receiving information specifying a target language.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments are chosen and described in order to best explain the principles of the invention and its practical applications, thereby enabling others skilled in the art to understand the invention for various embodiments, and with the various modifications as are suited to the particular use contemplated. It is intended that the scope of the invention be defined by the following claims and their equivalents.

It is to be noted that the entire disclosure of Japanese Patent Application No. 2005-60735 filed on Mar. 4, 2005 including specification, claims, drawings and abstract is incorporated herein by reference in its entirety.

What is claimed is:

1. A device for outputting translated document comprising:
a document input part that inputs document data to be translated;
a translation part that translates the document data inputted by the document input part;
an output destination specifying part that specifies an output destination of the translated document for each target language; and
an output destination switching part that switches the output destination of the translated document data based on the output destination specified by the output destination specifying part.

2. The device for outputting translated document of claim 1 further comprising the output part that outputs the translated document.

3. The device for outputting translated document of claim 1 further comprising:
a communication part that communicates with an external device; wherein,
the output destination switching part performs control for sending the translated document data of a particular language to the external device by the communication part, when an external output part is specified by the output destination specifying part as an output destination for a translated document of the particular language.

4. The device for outputting translated document of claim 2 further comprising:
a communication part that communicates with an external device; wherein,
the output destination switching part performs control for sending the translated document data of a particular language to the external device by the communication part, when an external output part is specified by the output destination specifying part as an output destination for a translated document of the particular language.

5. The device for outputting translated text of claim 1, further comprising:
a designation part that designates the translation part which is requested to perform a translation for each target language; and
a controller that performs switching control of a path of the document data, so that document data to be translated into a particular language is provided to the designated translation part for translation to the particular language.

6. The device for outputting translated document of claim 1, wherein the output destination specifying part further comprises a part that sends information indicating a target language to an output device specified as an output destination of the target language.

7. The device for outputting translated document described in claim 2, wherein:
the output destination specifying part further comprises a part that sends information indicating a target language to an output device specified as an output destination of the target language; and
the output device includes a display that displays a type of language when receiving information specifying a target language.

8. A method for outputting translated document comprising:
inputting document data to be translated;
translating the input document data;
specifying an output destination of the translated document for each target language; and
switching the output destination of the translated document data based on the specified output destination.

9. The method for outputting translated document of claim 8 further comprising outputting the translated document.

10. The method for outputting translated document of claim 8 further comprising:
communicating with an external device; wherein,
the switching step further sending the translated document data of a particular language to the external device, when an external output part is specified as an output destination for a translated document of the particular language.

11. The method for outputting translated document of claim 9 further comprising:
communicating with an external device; wherein,
the switching step further sending the translated document data of a particular language to the external device, when an external output part is specified as an output destination for a translated document of the particular language.

12. The method for outputting translated document of claim 8, further comprising:
designating the translation part which is requested to perform a translation for each target language; and
performing switching control of a path of the document data, so that document data to be translated into a particular language is provided to the designated translation part for translation to the particular language.

13. The method for outputting translated document of claim 8, wherein the specifying step further comprising sending information indicating a target language to an output device specified as an output destination of the target language.

14. The method for outputting translated document described in claim 9, wherein:
the specifying step further comprising sending information indicating a target language to an output device specified as an output destination of the target language; and
the output device includes a display that displays a type of language when receiving information specifying a target language.
